(19) United States
(12) Patent Application Publication
(10) Pub. No.: US 2020/0211307 A1
(43) Pub. Date: Jul. 2, 2020

(54) Methods and Software For Allowing Users to Interact With Smart-Structures Having Securable Occupiable Spaces That Provide Private Retreat Spaces for Users

(71) Applicant: Mamava, Inc., Burlington, VT (US)

(72) Inventors: Benjamin C. Lanza, Sheldon, VT (US); Andrew Pennell, Rockingham, VT (US)

(21) Appl. No.: 16/731,645

(22) Filed: Dec. 31, 2019

Related U.S. Application Data
(60) Provisional application No. 62/787,143, filed on Dec. 31, 2018.

(51) Int. Cl. G07C 9/00; G07C 9/29; H04W 12/06; H04W 76/10

(52) U.S. Cl. CPC G07C 9/00182; G07C 9/29; H04W 84/20; H04W 76/10; H04W 12/06

(57) ABSTRACT

A smart-structure that includes a securable occupiable space, access to which is controlled by a controller and a personal mobile computing device of a prospective occupant desiring to occupy the securable occupiable space. In some embodiments, access to the personal occupiable space is controlled by an electronic access-control lock that a prospective occupant can cause to unlock via personal area network (PAN) communications directly between a personal mobile computing device and the controller of the smart-structure. Once within the securable occupiable space, the controller may use an occupancy signal to provide the occupant with temporary control of one or more controllable environmental systems associated with the securable occupiable space. Other interactions between a prospective occupant/occupant, former occupant and the smart-structure are also disclosed.

### RELATED APPLICATION DATA

This application claims the benefit of priority of U.S. Provisional Patent Application Ser. No. 62/787,143, filed on Dec. 31, 2018, and titled “SELF-CONTAINED HABITABLE SMARTPODS HAVING A CENTRAL POD CONTROL DEVICE AND/OR APP-BASED ENVIRONMENTAL CONTROLS,” which is incorporated by reference herein in its entirety.

### FIELD OF THE DISCLOSURE

The present disclosure generally relates to the field of habitable smart-structures. In particular, the present disclosure is directed to methods and software for allowing users to interact with smart-structures having securable occupiable spaces that provide private retreat spaces for users.

### BACKGROUND

Various types of personal retreat spaces are increasingly being deployed in public and private spaces. In a common and nonlimiting example, this is especially true for airports, where people often need to spend a significant amount of time waiting for flights, not only when flight delays occur due to weather and other events but also due to routine scheduling of flights that are spaced apart in time. As air travelers know, the lengthy time spent in airports can be physically taxing and challenging, especially for long-distance travelers, business travelers, and various other segments of the population, such as nursing mothers. As a result, private resting spaces, work spaces, and nursing spaces can be seen in increasing numbers in airports.

### SUMMARY OF THE DISCLOSURE

In an implementation, the present disclosure is directed to a method, performed by a controller of a smart-structure having a securable occupiable space having an access lock for preventing access to the securable occupiable space, of interacting with a personal mobile computing device of a person desiring to occupy the securable occupiable space, wherein the smart-structure has a first personal area network (PAN) communications system and the personal mobile computing device includes a second PAN communications system. The method includes automatically establishing a PAN communications channel between the first PAN communications system and the second PAN communications system; receiving credentials from the personal mobile computing device via the PAN communications channel; verifying the credentials as being access credentials; and triggering the access lock to unlock so as to permit the person to enter the securable occupiable space.

### BRIEF DESCRIPTION OF THE DRAWINGS

For the purpose of illustrating embodiments, the drawings show aspects of one or more embodiments. However, it should be understood that the present disclosure is not limited to the precise arrangements and instrumentalities shown in the drawings, wherein:

FIG. 1 is a high-level diagram illustrating an example smart-structure system made in accordance with aspects of the present disclosure;

FIG. 2 is a flow diagram illustrating an example method of a smart-structure interacting with a personal mobile computing device of a person desiring to use a securable occupiable space of the smart-structure;

FIG. 3 is diagram illustrating an example locking/unlocking system that can be used in a smart-structure of the present disclosure, such as the smart-structure of FIG. 1, to secure a securable occupiable space of the smart structure;

FIGS. 4A and 4B are screenshots of, respectively, a control graphical user interface (GUI) for controlling an HVAC system and an ambient-lighting system of a securable occupiable space of the present disclosure;

FIG. 5A is a perspective view of an example nursing pod showing the wall closest to the viewer removed to show features within the securable occupiable space within the nursing pod;

FIG. 5B is a perspective exploded view of the nursing pod of FIG. 5A, showing various components of the nursing pod;

FIG. 6 is a high-level schematic diagram illustrating functionalities of an example pod control device (PCD) usable with a smart-structure of the present disclosure, such as the nursing pod of FIGS. 5A and 5B;

FIG. 7 is a view of a prospective occupant's personal mobile computing device, showing an unlock screen displayed by a securable-occupiable-space (SOS) app on the personal mobile computing device in response to paring with a PCD of a smartpod of the present disclosure;

FIG. 8 is a flow diagram illustrating an example of how a PCD of a smartpod of the present disclosure pairs with a prospective occupant's personal mobile computing device and subsequently unlocks the smartpod;

FIG. 9 is a flow diagram illustrating an example of how a PCD of a smartpod of the present disclosure interacts with an SOS app on an occupant's personal mobile computing device, including passing temporary control of onboard environmental systems to the SOS app;

FIG. 10 is a schematic diagram of an example computing system that can be used to implement any one or more of the aspects, functionalities, features, and/or functionalities, or portion(s) thereof, described herein.

### DETAILED DESCRIPTION

For the sake of convenience and to provide a reader with an understanding of aspects of the present disclosure, the following terms shall have the following meanings throughout this disclosure and appended claims.

“Smart-structure”: Any structure that includes one or more securable occupiable spaces and includes one or more controllers for controlling access to the securable occupiable space(s) via one or more communications channels. A smart-structure can be a standalone structure or part of a larger structure. Examples of standalone structures include pods. An example of a standalone pod is the MAMAVA lactation station available from Mamava, Inc., Burlington, Vt., that is available to nursing mothers for breastfeeding and breast pumping. Other standalone single pods currently in use include personal retreat spaces deployed in larger facilities, such as airports, open office spaces, retail stores, stadiums, and other public and non-public spaces where a person may want privacy and/or isolation. Examples of other personal retreat spaces include sleep spaces, work spaces, isolation spaces, and relaxation spaces among others. Securable occupiable spaces of pods can be sized for a small number of people, such as one, two, three, or more people, depending on the use(s) of the securable occupiable spaces.

A standalone smart-structure can be a standalone multi-space unit containing two or more securable occupiable spaces, which can be the same as or similar to the example securable occupiable spaces noted above for pods. Such a standalone unit may be configured such that it can be generally likened to a shipping container, a roadgoing trailer, a module of a modular building, or an assembly of such modules, among others. Standalone multi-space units can be designed and configured to be located within interior spaces of larger buildings or outside where it is subjected to weather. Standalone smart-structures may be constructed either at or away from their deployed locations.

Examples of smart-structures that are part of larger structures include smart-structures that are built into a larger structure, for example, using conventional build-out construction techniques such as stud-and-panel (e.g., wallboard) techniques. Like standalone smart-structures, built-in smart-structures may have a single securable occupiable space or multiple securable occupiable spaces.

“Securable occupiable space”: An interior space within a smart-structure where one or more people can separate themselves from other people and that can be secured to prevent unauthorized access during a use session. As discussed above relative to smart-structures, a securable occupiable space may have any one or more of a variety of uses, and each securable occupiable space can be outfitted and configured as needed for such use(s). Fit-up items may include but not be limited to one or more seats (e.g., built-in), one or more beds, one or more desks, one or more cabinets, shelves, and/or other object storage or placement structures, audio system, audio-visual system(s), among a wide variety of other fit-up items. A securable occupiable space may be accessible via one or more securable closures, such as a hinged-door, laterally retractable closure (e.g., sliding door), vertically moving closure, among others. Fundamentally, the form of each closure can be any that suit the purpose(s) of privacy and/or isolation. A securable closure may be manually operated by a person or automatically actuated by an actuator mechanism of the smart-structure.

A securable closure may be secured, or locked, using one or more lock systems. For example, a securable closure may include an access-control locking system (e.g., access-control lock) and a privacy locking system. The access-control locking system may be a locking system that prevents the securable closure from being opened by an unauthorized person when the securable occupiable space is unoccupied. The privacy locking system may be a locking system that is engaged separately from the access-control locking system by a person within the securable occupiable space. In an example, the authorized-access system may include an electronic lock controlled by an authorization signal, such as an electronic signal from a controller of the smart-structure, a wireless signal (e.g., via nearfield communication, RFID, infrared, magnetic strip reader, etc.), or a signal from an integrated keypad, among others. In an example, the privacy locking system may include a mechanical interior deadbolt lock or an electronic equivalent. An aspect of the privacy locking system is that it is essentially only controllable by a person inside the corresponding securable occupiable space.

A use session may be of a predetermined amount of time, a predetermined maximum amount of time, or a user-determined amount of time, or a combination thereof. The length of a use session can vary according to any one or more of a variety of factors including, but not limited to, the type of use, the amount of time requested by a particular user, or the amount of time corresponding to a particular amount of payment, among others.

“Controller”: One or more electronic devices responsive to machine-executable instructions for performing any one or more of a variety of operations. Each of some or all of the electronic devices may include a microprocessor and/or a microcontroller. The term “controller” can include any corresponding memory of any type that stores the machine-executable instructions. In some embodiments, the controller at issue may be centralized, in some cases being unitized with one or more other electronic systems of a smart-structure or corresponding securable occupiable space. In some embodiments, the controller at issue may be distributed among one or more microprocessor and/or microcontrollers, either onboard a smart-structure or offboard the smart-structure, or a combination of onboard and offboard the smart-structure. A controller may be configured to control a single securable occupiable space or multiple securable occupiable spaces. If a controller is configured to control multiple securable occupiable spaces, it may be configured to control each of the securable occupiable spaces independently from one another. Examples of operations that a controller may perform are described below and may include, but not be limited to, controlling interactions and communications with personal mobile computing devices of people, including occupants of a securable occupiable space, controlling communications with one or more servers located offboard a smart-structure (such as servers accessible via the Internet), controlling each of one or more controllable environmental systems of a corresponding securable occupiable space, controlling how a controllable environmental system is controlled (e.g., by an occupant, such as via a personal mobile computing device), controlling access to the securable occupiable space, and monitoring the health of any one or more systems aboard a smart-structure or one or more securable occupiable spaces, among others.

“Controllable environmental system”: A system that provides a securable occupiable space with one or more sensory stimulants and/or occupant-comfort effects and that can be permissively controlled by an occupant of the securable occupied space. Examples of controllable environmental systems include, but are not limited to, a lighting system, a sound system, a temperature-control system, a multimedia system, a ventilation system, a humidity control system, and a scent-dispensing system, among others. A controllable environmental system may be controlled by a controller of a smart-structure or securable occupiable space.

“Occupancy sensor”: One or more devices that can detect the presence of one or more people in a securable occupiable space. An occupancy sensor can include, but not be limited to, a deadbolt switch activated by a deadbolt located, and user-actuatable only from, within the securable occupiable space, a thermal sensor that senses a person's body heat when the person is present in the securable occupiable space, a motion sensor that senses movement of a user when present in the securable occupiable space, a vision sensor for visually detecting a person when the person is present in the securable occupiable space, a pressure sensor for sensing weight of a person when the person is present in the securable occupiable space, a radio-signal-strength sensor system that, for example, can triangulate when an occupant's personal mobile computing device is present within the securable occupiable space, and a wireless communications system that can receive location information from an occupant's personal mobile computing device, among others, and any combination thereof. Depending on whether or not data processing is needed to process data from the one or more devices and/or from another source (such as an image database) to determine presence, the term “occupancy sensor” may include the machine-executable instructions, memory therefor, and corresponding microprocessor(s) for processing such data.

“Personal mobile computing device”: Any electronic computing device or computing system carried by a person that intends to become an occupant of a securable occupiable space of the present disclosure and that includes one or more wireless communications devices (e.g., radios, infrared devices, nearfield devices, etc.) for communicating with one or more corresponding communications devices of a smart-structure or securable occupiable space and/or a network, such as a wireless local area network and/or cellular network, and that includes a user interface (e.g., and electronic display) that allows a person to interact with a controller of a smart-structure or securable occupiable space and/or a network-based portal associated with the smart-structure or securable occupiable space. Examples of personal mobile devices include, but are not limited to, smartphones, smart wearables (e.g., smartwatches, smartglasses, etc.) tablet computers, laptop computers, etc., and any combination thereof. Fundamentally, there is no limitation on the type of personal mobile computing device other than it be able to provide the functionality(ies) disclosed herein for effecting the disclosed subject matter. Generally, a personal mobile computing device will include one or more microprocessors for executing machine-executable instructions for any suitable software, such as an operating system and any of a wide variety of software applications (apps), such as a browser app and a securable occupiable space app (see below), among many others. A personal mobile computing device will include at least one wireless communications system, such as any one or more of a personal area network communications system, a wireless local area network communications system, and a cellular network communications system. A personal mobile computing device will also include memory, which, collectively, can include any one or more of memories typically associated with computing devices, such as volatile memory (e.g., random access memory, cache memory) and nonvolatile memory (e.g., flash memory, read-only memory, solid-state hard drive, magnetic hard drive, optical drive) and/or any alternative thereto or replacement therefor.

“Securable occupiable space (SOS) app”: A computer application executable on a personal mobile computing device that provides any one or more of a variety of features regarding a securable occupiable space and/or a network of securable occupiable spaces. In some embodiments, an SOS app is provided by a provider of a network of securable occupiable spaces. As an illustrative, but nonlimiting, example, a smart-structure provider (e.g., owner, lessor, manager, etc.) may provide a network of lactation-station pods placed in various locations, such as airports, train stations, bus stations, shopping malls, theaters, arenas, etc., along with an SOS app that allows a person to utilize one or more of the securable occupiable spaces within the network. In some embodiments, people subscribe to be able to use one or more securable occupiable spaces within the network. Features that an SOS app may have include, but are not limited to, interactive mappings and/or listings of securable occupiable space locations, which may include current occupancy status(es), account setup/change/information, payment setup/change/information, vacancy alerting, directions, scheduling (e.g., booking or holding), control(s) for one or more controllable environmental systems of a securable occupiable space when present in that securable occupiable space, a control for engaging an “electronic deadbolt” when present in the securable occupiable space, comment/rating, provider provided advertising, and direct-messaging (e.g., for provider assistance), among others, and any combination thereof.

“Securable occupiable space (SOS) network portal”: A portal, such as a web portal, provided on one or more network servers that provides functionality and features the same as or similar to the functionalities and features of the SOS app described above. In some embodiments, a person may access an SOS network portal via a browser app on any suitable type of computing device or network appliance, including a personal mobile computing device as described above.

“Personal area network (PAN)”: A communications network revolving around a person and directly communicates between a personal mobile computing device and a controller onboard a nearby smart-structure. The PAN may be established by a pair of communications transceivers, such as radio transceivers, a pair of infrared transceivers, a pair of visible-light transceivers, a pair of ultrasonic transceivers, or a pair of other transceivers. In one example, a pair of radio-frequency (RF) transceivers and corresponding radio controllers are configured to established a PAN via an Internet of Things (IoT) technology, such as the BLUETOOTH® Low Energy (BLE) technology of the Bluetooth Special Interest Group standards organization, Kirkland, Wash. Another PAN technology, such as another technology under a standard under the IEEE 802.15 wireless PAN working group, among others. In some embodiments, the range of a PAN of the present disclosure is up to about 30 meters, up to about 20 meters, up to about 10 meters, up to about 5 meters, as nonlimiting examples.

“Wireless local area network (WLAN)”: A wireless communications network that allows each of a personal mobile computing device and a controller of a smart-structure to connect to the Internet or to a private server network, e.g., within an organization, wirelessly, such as via a wireless router. The WLAN may be established by a pair of communications transceivers such as RF transceivers, a pair of infrared transceivers, a pair of visible-light transceivers, a pair of ultrasonic transceivers, or a pair of other transceivers. In one example, a pair of RF transceivers and corresponding radio controllers are configured to established a WLAN via a Wi-Fi technology under an IEEE 802.11 standard.

“Cellular network”: A wireless mobile communications network that allows a mobile communications device to move over relatively large geographical areas while staying functionally connected to the cellular network by moving the connection from one cell to another cell as the mobile communications device moves. In one example, a wireless mobile communications device, such as a personal mobile computing device and a controller of the present disclosure, among others, is associated with a cellular network via a subscriber identification module (SIM) card or similar device that uniquely identifies the wireless mobile communications device to the cellular network. The wireless communications network is typically established by a cellular network radio and corresponding radio controller aboard the wireless communications device that communicates with one or more corresponding cellular network radios at corresponding respective cellular communications stations (antenna(s) plus radio(s), and network connection(s)). In one example, a wireless mobile communications network for a controller of the present disclosure may be based on a long-term-evolution machine-type communications (LTE-M) technology or an equivalent or replacement technology, among others. In one example, a wireless communications network for a personal mobile computing device, if so equipped, may be based on LTE or other wireless broadband communications standards, among others.

With the foregoing terms and meanings in mind, in some aspects the present disclosure is directed to methods of interacting with the personal mobile computing device of a person desiring to temporarily occupy a securable occupiable space provided by the smart-structure. As will be described below in detail, the interacting between the controller and the personal mobile computing device can be for any one or more of a variety of purposes, such as allowing the person to gain access to the securable occupiable space, allowing the person to engage an electronic deadbolt, allowing the person to interact with one or more environmental systems of the securable occupiable space, causing digital content to be presented to the person, and causing geotargeted advertising to be presented to the person, among other things, and any combination thereof.

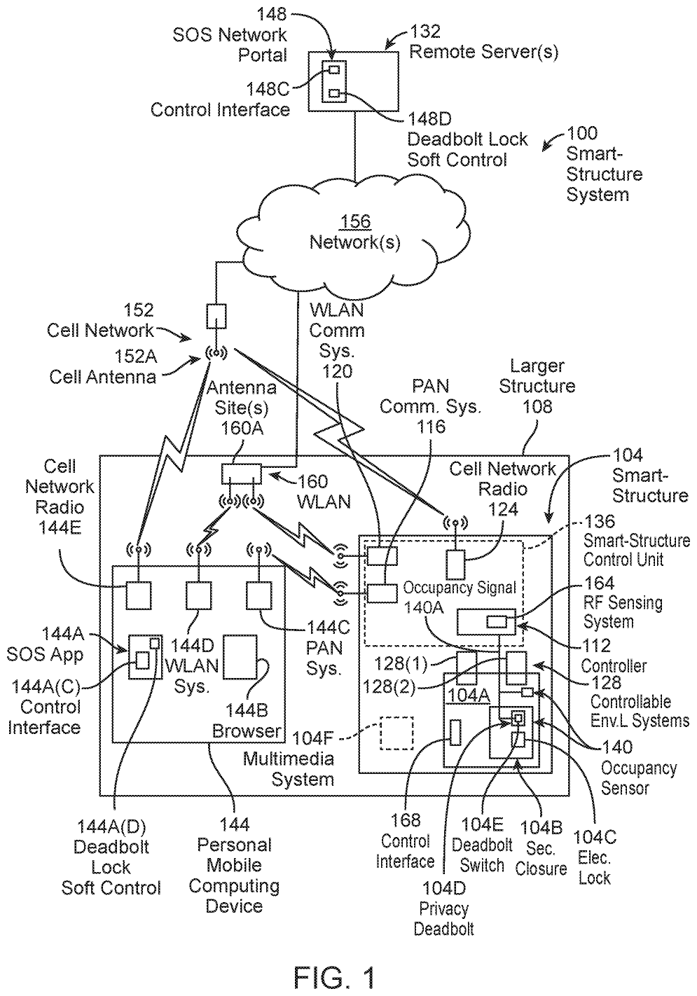

For the sake of illustration, but not limitation, FIG. 1 illustrates an example smart-structure system 100 made in accordance with aspects of the present disclosure. In this example, the smart-structure system, or simply “system”, 100 includes one or more smart-structures 104 (only one shown for ease of illustration, but could be tens, hundreds, thousands, etc.), with the sole smart-structure shown being deployed within a larger structure 108, such as an airport, as a simple example.

In this particular example, the smart-structure 104 contains a single securable occupiable space 104A that is secured by a securable closure 104B that is lockable via an electronic lock 104C, and/or a mechanical interior deadbolt privacy lock 104D. In this example, the mechanical interior deadbolt privacy lock 104D actuates a deadbolt switch 104E. In one embodiment, the electronic lock 104C includes an electronic access-control lock (not separately shown) and may further include an electronic privacy lock (not separately shown). In one example, if an electronic privacy lock is provided, as described below, it may be actuated only by action of a person when the person is present within the securable occupiable space 104A.

The securable occupiable space 104A of this example is associated with a controller 112, a PAN communications system (here, a PAN radio 116 (e.g., a BLE radio) (and corresponding software)), a WLAN communications system (here, a WLAN radio 120 (e.g., a Wi-Fi radio) (and corresponding software)), and a cellular network radio 124 (e.g., an LTE-M compatible radio) (and corresponding software)). In other embodiments, the securable occupiable space 104A need not be associated with all three of the PAN communications device 116, the WLAN communications device 120, and the cellular network radio 124. For example, the securable occupiable space 104A may be associated with one or two of these. If the securable occupiable space 104A is associated with only one of these devices/radio, it will typically be the PAN communications device 116. If the securable occupiable space 104A is associated with two of the devices/radio, it may be associated with the PAN communications device 116 and the cellular network radio 124. As another example, the securable occupiable space 104A may be associated with the PAN communications device 116 and the WLAN communications device 120.

On the controllable environmental systems front, for simplicity the example smart-structure 104 includes only two controllable environmental systems 128, here a heating ventilating, and air-conditioning (HVAC) system 128(1) and an ambient-lighting system 128(2). The HVAC system 128(1) allows a person (not shown) present in the securable occupiable space 104A to control the ambient temperature within the securable occupiable space in any one or more of a variety of ways as described below. The ambient lighting system 128(2) allows a person present in the securable occupiable space 104A to control the ambient lighting within the securable occupiable space in any one or more of a variety of ways as described below.

To keep this particular smart-structure 104 simple and relatively low cost and low maintenance, it does not include other electronics, such as a multimedia systems among others. However, other smart-structures may optionally include a multimedia system 104F and/or one or more other electronic systems (not shown), at least some of which may or may not be a controllable environmental system. If any of the multimedia systems 104F and/or other electronic system(s) are not a controllable environmental system, it may be under the control of the controller 112, either directly or via remote software, such as one or more remote servers 132 (only one shown for simplicity). In some embodiments, the controller 112, PAN communications device 116, WLAN communications device 120, cellular network radio 124, and/or various components of one or both of the HVAC system 128(1) and the ambient lighting system 128(2) may be provided as a smart-structure control unit 136 that can be configured essentially as a plug and play module having quick-connector electrical connectors for making the necessary electrical connection(s) to power any other components, such as fan(s) (not shown), the electronic lock 104C, etc., not onboard the smart-structure control unit.

As described below, the securable occupiable space 104A includes an occupancy sensor 140 that can be either the deadbolt switch 104E or the electronic privacy lock, or both. However, as described above relative to the explanation of the term occupancy sensor as used herein and in the appended claims, the occupancy sensor 140 can include any one or more of a variety of other devices.

In this example, the system 100 further includes a personal mobile device 144, which may include an SOS app 144A for allowing a person using the personal mobile device to perform any of a wide variety of functions relative to the securable occupiable space 104A and any other securable occupiable space(s) that may be in a network of securable occupiable spaces. In this connection, the remote server(s) 132 may include an SOS network portal 148 that can provide the same or similar functionality as the SOS app 144A, either as an alternative for the person using the personal mobile device 144 or in lieu of the SOS app. The SOS network portal 148 may be accessible via a corresponding uniform resource locator (URL). To allow the person to access the SOS network portal 148, the personal mobile device 144 may include a browser 144B (e.g., an Internet or web browser) that allows the person to access the SOS network portal 148, for example, via the corresponding URL.

As mentioned above, the personal mobile computing device 144 may include any one or more of a PAN communications system (here, a PAN radio 144C (e.g., BLE radio) (and corresponding software)), a WLAN communications system (here, a WLAN radio 144D (e.g., a Wi-Fi radio) (and corresponding software)), and a cellular network radio 144E (e.g., an LTE-M compatible radio) (and corresponding software)). In other embodiments, the personal mobile computing device 144 may have fewer and/or different types of wireless communications systems to suit a particular architecture.

PAN radio 144C of the personal mobile computing device 144 allows the personal mobile computing device to communicate directly with the PAN radio 116 of the smart-structure 104, for example, to provide the person access to the securable occupiable space 104A, to communicate occupancy status via the personal mobile computing device to the person, to optionally allow the person to actuate an electronic deadbolt of the electronic lock 104C, and to allow the person to control HVAC system 128(1) and ambient-lighting system 128(2) via the personal mobile computing device, among other things.

Cellular network radio 144E of the personal mobile computing device 144 allows the personal mobile computing device to communicate with the controller 112 of the smart-structure 104 or the SOS network portal 148, or both, via a cellular network 152, e.g., via one or more cell antennas 152A (only one shown for convenience) and the Internet and/or other network(s), which are collectively represented by network(s) 156. WLAN radio 144D of personal mobile computing device 144 may also allow the personal mobile computing device to communicate with the controller of the smart-structure 104 or the SOS network portal 148, or both. However, depending upon the ability of the person controlling the personal mobile computing device 144 to access a WLAN, such as WLAN 160, which may be private/passcode protected, the person may not have access to the WLAN. If so, however, the nature of the interactions may be the same as or similar to the interactions that could occur via the cellular network. WLAN 160 may have one or more WLAN antenna sites 160A (only one shown for convenience) via which the personal mobile computing device may connect to the WLAN 160.

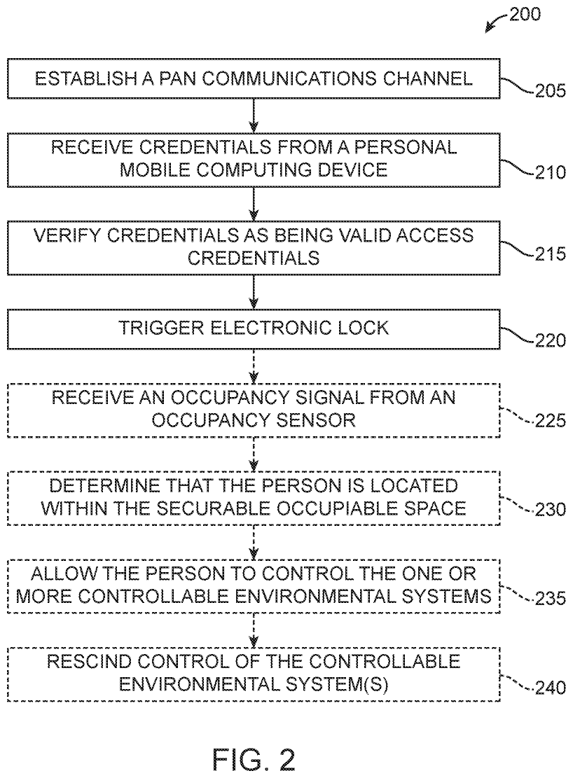

FIG. 2 illustrates a method 200 that can be performed by a controller of a smart-structure, such as controller 112 of smart-structure 104 of FIG. 1. While method 200 need not necessarily be performed by controller 112 and the smart-structure at issue need not be smart-structure 104, the smart-structure system 100 of FIG. 1 is used as an illustration. Should any of the steps or other actions described for method 200 be limited by any particular aspect(s) of smart-structure system 100, such limitation(s) should not be imputed into method 200.

Referring now to FIG. 2, at block 205 of method 200 a PAN communications channel may be established between the PAN communications system 116 of the smart-structure 104 and the PAN communications system 144C of the personal mobile computing device 144. As noted above, a PAN has a relatively limited communications range, such as 30 meters or less. To illustrate in the context of a BLE communications technology, say the communications range is 20 meters. In one example, the PAN communications system 116 (BLE radio) of the smart-structure 104 may operate as a master radio and the PAN communications system 144C (BLE radio) of the personal mobile computing device 144 may operate as a slave radio. Once the person carrying the personal mobile computing device 144, which may have a unique media access control (MAC) address, is within the 20-meter communications range, the master and slave radios may communicate with one another, for example, using a BLE connection protocol, to establish the PAN communications channel. Those skilled in the art will readily understand how the PAN communications systems 116 and 104C can establish the PAN communications channel based on the technology and protocol(s) at issue.

At block 210, the controller 112 may receive credentials from the personal mobile computing device 144 via the PAN communications channel established between the PAN communications systems 116 and 144C. These credentials may be any suitable authentication code (e.g., sequence of characters or other information) that identifies the personal mobile computing device 144 as belonging to or otherwise associated with a person that is authorized to use the securable occupiable space 104A either currently or when available (e.g., unoccupied). In an example, the credentials may be a MAC address of the personal mobile computing device 144, a serial number that identifies the copy of the SOS app 144A aboard the personal mobile computing device, a unique user authorization code assigned to the person (e.g., by the provider of the securable occupiable space 104A), among others, or any combination thereof. Fundamentally, there is no limitation to the credentials as long as they establish that the PAN communications channel is between the controller 112 and a person (actually, their personal mobile computing device 144) properly authorized to be in direct communications with the controller. In an example, the credentials can be delivered to the personal mobile computing device 144 in conjunction with the person seeking permission to use the personal occupiable space 104A via SOS app 144A or SOS web portal 148. Such permission seeking and credentials delivery may occur at any suitable time, including when the person is located proximate to the smart-structure 104, such as just outside of the securable closure 104B.

At block 215, the controller 112 verifies that it is to consider the credentials as being access credentials that it uses as authorization to trigger the electronic lock 104C to unlock the securable closure 104B to allow the person carrying the personal mobile computing device 144 to enter the securable occupiable space 104A. The controller can verify the credentials in any one or more of a variety of ways. In an example, the controller 112 may have a locally stored list of credentials of authorized users (or users' personal mobile computing devices) against which the controller can compare the credentials it just receives from the personal mobile computing device 144 via the PAN communications channel. In an example, the controller 112 may perform the verification by querying the remote server(s) 132 to provide a requested verification.

At block 220, the controller 112 triggers the electronic lock 104C (a/k/a “access-control lock” when referring to controlling entry to the securable occupiable space 104A, especially when the securable occupiable space is unoccupied) to unlock the securable closure 104B to allow the person carrying the personal mobile computing device 144 to enter into the securable occupiable space. The controller 112 may trigger electronic lock 104C to unlock the securable closure 104B in any suitable manner either via a wired connection or a wireless connection using an unlock signal (not shown), depending on the configuration and functionality of the electronic lock. The unlock signal may be any suitable signal, including a simple trigger signal or an encoded signal encoded with a predetermined unlock code, among others.

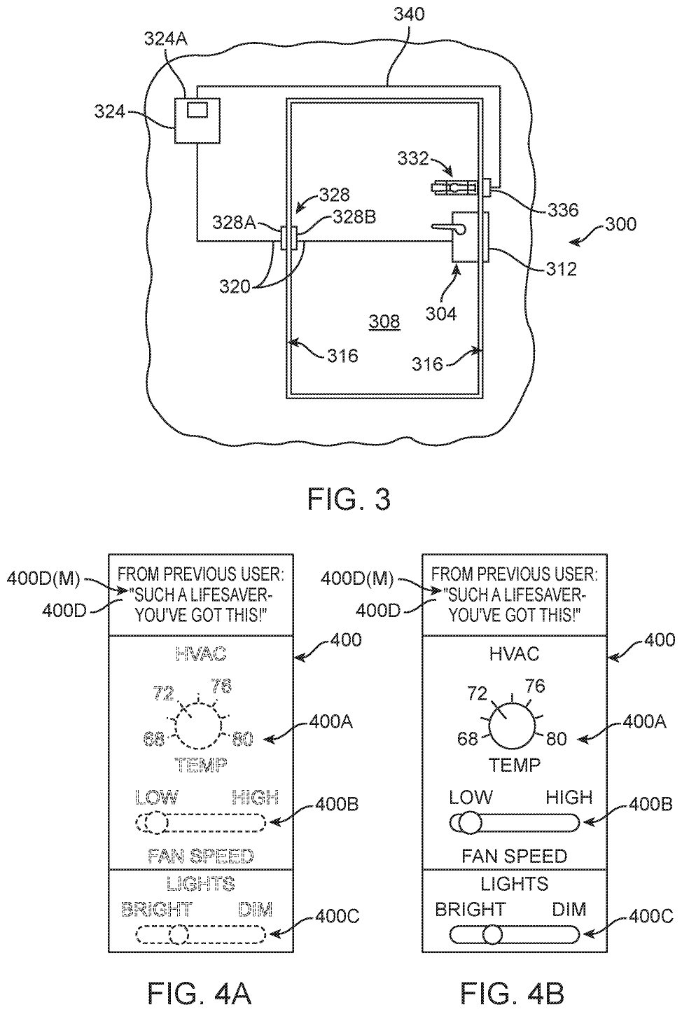

FIG. 3 illustrates an example electronic locking/unlocking system 300 that can be used for a smart-structure made in accordance with the present disclosure, such as smart-structure 104 of FIG. 1. As seen in FIG. 3, electronic locking system 300 includes an electronic lock 304 mounted to a securable closure (here, a horizontally swinging hinged door 308) and having a catch 312 located on a doorjamb 316 of the smart-structure 104. In this example, electronic lock 304 is powered by direct-current DC power provided via wiring 320 that runs from a central control unit 324 to the electronic lock 304. In this example, a section of the wiring 320 is run on the hinged door 308 independently from the rest of the wiring by using a set 328 of electrical contacts 328A, 328B on the doorjamb 316 and on the hinged door, respectively. When the hinged door 308 is in its closed position, for example, with the hinged door locked by the electronic lock 304, the electrical contacts 328B on the hinged door are in physical contact with the electrical contacts 328A on the doorjamb 316, thereby completing the corresponding electrical pathway(s). When a person entering or exiting the securable occupiable space (not shown) opens the hinged door 308, the electrical contacts 328B on the hinged door move away from the electrical contact 328A on the doorjamb 316, thereby breaking the electrical pathway(s). In this example, wiring 320 also includes signal wiring (not shown separately). As described below, the use of the set 328 of electrical contacts 328A, 328B can be leveraged for one or more uses other than simply providing power or lock and/or unlock signals to the electronic lock 304. Central control unit 324 in this example includes a controller 324A, which may be the same as or similar to the controller 112 of FIG. 1.

Referring back to FIGS. 1 and 2, at block 225 the method 200 (FIG. 2) may optionally further include the controller 112 receiving an occupancy signal 140A from the occupancy sensor 140 based on the person entering and being present in the securable occupiable space 104A. The occupancy signal 140A is any signal that indicates to controller 112 that the person is located within the securable occupiable space 104A. If the occupancy sensor 140 is a dedicated presence sensor (such as a motion sensor, a thermal sensor, a pressure sensor, a machine-vision sensor, etc.,) the occupancy signal 140A may be one or more signals generated by such presence sensors.

In another example, the occupancy sensor 140 may be a manually operated privacy deadbolt lock, such as privacy deadbolt lock 104D and/or corresponding deadbolt switch 104E. The deadbolt lock 104D is located on the interior of the securable occupiable space 104A such that the only way it could be actuated is for a person to be within the securable occupiable space 104A with the securable closure 104B in its fully closed position. Thus, after a person enters the securable occupiable space 104A and closes the securable closure 104B, they may actuate the privacy deadbolt lock 104D, which engages the deadbolt switch 104E to generate a signal that controller 112 may receive directly or indirectly (e.g., as a digitized signal) as the occupancy signal 140A. A benefit of a privacy deadbolt lock 104D is that is can make the person/people within the securable occupiable space 104A feel secure and comfortable within the securable occupiable space because they are the only one(s) that can, perhaps ostensibly, engage the privacy deadbolt lock. FIG. 3 illustrates an example mechanical privacy deadbolt lock 332 and corresponding deadbolt switch 336 located on the interior of the securable occupiable space. In this example, the deadbolt switch 336 is connected to the central control unit 324 via signal wiring 340. This privacy deadbolt lock and deadbolt switch 336 may be used for privacy deadbolt lock 104D and deadbolt switch 104E of FIG. 1, if desired. Those skilled in the art will readily appreciate that privacy deadbolt lock 104D and privacy deadbolt switch 104E need not be separate from the electronic lock 104C and indeed may be incorporated into the electronic lock, even in mechanical form.

In another example, the occupancy sensor 140 may be a signal sensing system 164 that can determine the location of the personal mobile computing device 144 based on one or more signals being emitted from the personal mobile computing device. Such signal(s) may be emitted, for example, by PAN radio 144C, WLAN radio 144D, and/or cell network radio 144E, and the signal sensing system 164 may determine the position of the personal mobile computing device 144 based on signal strength and/or triangulation using one or more suitable antennas. In this example, the output of signal sensing system 164, or a suitable processed version thereof, may be considered the occupancy signal 140A.

In another example, the occupancy sensor 140 may simply be the controller 112 itself. For example, the controller 112 may obtain GPS location data from the personal mobile computing device 144, for example, via any one of PAN radio 144C, WLAN radio 144D, and cell network radio 144E, or its non-RF equivalent communications system. If so, the occupancy signal 140A may contain GPS location data containing the location of the personal mobile computing device 144.

Referring again to FIG. 2, and also to FIG. 1, at optional block 230, the controller 112 may use the occupancy signal 140A to determine that the person associated with the personal mobile computing device 144 is located within the securable occupiable space 104A. Once the controller 112 has determined that the person associated with the personal mobile computing device 144 is located within the securable occupiable space 104A via the occupancy signal 140A, it may use this determination for any one or more of a variety of purposes. In one example, the controller 112 may use the determination to allow the person to perform a task that they were unable to perform prior to the controller determining that the person is within the securable occupiable space 104A.

For example, at optional block 235 the controller 112 may allow the person to control one or more of the controllable environmental systems 128 via their personal mobile device 144 and/or via one or more control interfaces 168 incorporated into the smart-structure 104 within the securable occupiable space 104A. This allowance of control by the controller may take any one or more of a variety of forms, and the control may be effected via any one or more control interfaces, including one or more control interfaces 144A(C) of SOS app 144A, one or more control interfaces 148C of SOS network portal 148, or the one or more control interfaces 168 of the smart-structure 104, or any combination thereof. Examples of forms of the allowance of control include, but are not limited to, activating previously deactivated soft controls (e.g., sliders, radio buttons, checkboxes, dials, voice-activated controls, etc.), sending an access signal to unlock the SOS app 144A and/or to the SOS network portal 148 to allow access to one or more soft controls, providing a pop-up window containing suitable soft controls, providing a URL link to suitable soft controls, or activating hard controls, if such controls are provided with the control interface(s) 168. In this connection, if control interface(s) 168 is/are provided with the smart-structure 104, some or all may be hard controls and/or some or all may be soft controls provided, for example, on one or more touchscreen and/or voice-activated devices. Fundamentally, the manner in which the controller 112 provides the ability to the person to control is not limited in any particular way other than that ability was not present to the person prior to the controller providing the ability based on the occupancy signal 140A indicating that the person is present within the securable occupiable space.

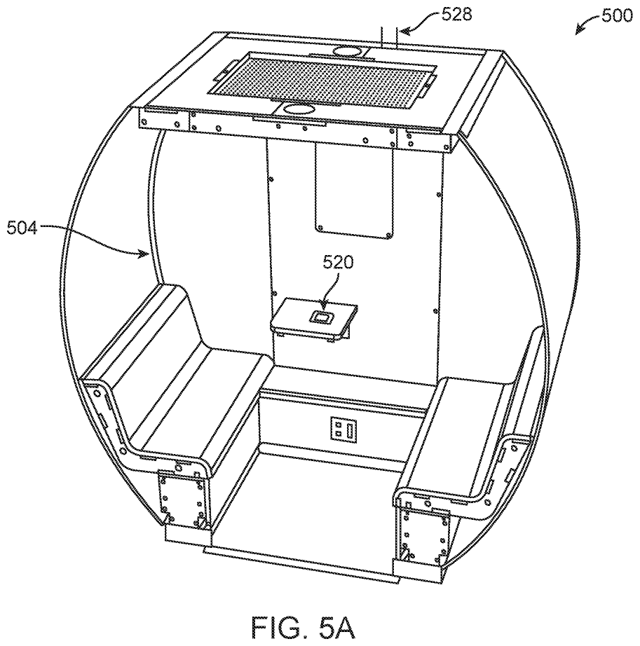

FIGS. 4A and 4B illustrate a simple local-SOS graphical user interface (GUI) 400 having a variety of features for the current securable occupiable space 104A that the current person is in or proximate to. For example, local-SOS GUI 400 includes features for controlling the HVAC system 128(1) and the ambient-lighting system 128(2) of the securable occupiable space 104A of FIG. 1. The control interface 400 may be any one or more of the control interfaces 144A(C), 148C, and 168 of FIG. 1. In this example, for the HVAC system 128(1) the local-SOS GUI 400 includes a temperature soft dial 400A and a fan-speed soft slider 400B. When active (FIG. 4B), the temperature soft dial 400A allows the person within the securable occupiable space 104A of FIG. 1 to set the temperature that the person desires the securable occupiable space to be during their use session. Similarly, the fan-speed soft slider 400B allows the person within the securable occupiable space 104A to set a fan (not shown) of the HVAC system 128(1) to a desired speed during the use session. Also in this example, for the ambient-lighting system 128(2) the local-SOS GUI 400 includes a light-intensity soft slider 400C, which, when active (FIG. 4B) allows the person within the securable occupiable space 104A of FIG. 1 to adjust the brightness of the ambient lighting within the securable occupiable space. In FIG. 4A, the temperature soft dial 400A, the fan-speed soft slider 400B, and the light-intensity soft slider 400C are “grayed-out,” indicating that they are not active, i.e., the person cannot use them to control the HVAC and ambient-lighting systems 128(1) and 128(2). In this example, this grayed-out state of the temperature soft dial 400A, the fan-speed soft slider 400B, and the light-intensity soft slider 400C is what the person will see prior to the controller 112 providing the person with control for a use session and then again after the controller has rescinded the control from the person. As noted above, FIG. 4B shows the temperature soft dial 400A, the fan-speed soft slider 400B, and the light-intensity soft slider 400C in their non-grayed-out, or active, states as they appear to the person once the controller has provided the person with the ability to control the HVAC system 128(1) and the ambient-lighting system 128(2) and before rescinding such control.

In the example shown in FIGS. 4A and 4B, local-SOS GUI 400 also includes a message region 400D that may display any message that the smart-structure provider wants a user to see. In the present example, message region 400D contains a message 400D(M) that is left for the current occupant of the securable occupiable space 104A (FIG. 1) by the immediately prior occupant of the securable occupiable space, or perhaps an occupant before that if the immediately prior occupant has not entered any message. In this example, each current occupant is encouraged to provide a message, such as words of support, to the next occupant, for example to create a sense of community. Here, the immediately previous occupant left the message: “Such a lifesaver—you've got this!”, which alludes to the fact that the immediately previous occupant was happy that the securable occupiable space 104A was available and wanted to provide words of encouragement to the next occupant. In an example, each message left by an occupant, such as message 400D(M), may be stored on the one or more remote servers 132 (FIG. 1), such as by a backend (not shown) of SOS network portal 148. In the present example, message 400D(M) is not grayed-out at any time. That is, as soon as SOS GUI is presented to the current (prospective) occupant (e.g., in response to the current prospective occupant causing the controller 112 to unlock the securable occupiable space 104A), the message 400D(M) is displayed to the current (prospective) occupant in full (non-grayed-out) form.

When the person within the securable occupiable space 104A is controlling a controllable environmental system via one or more control interfaces 144A(C) of SOS app 144A on the personal mobile computing device 144, the communications link between the personal mobile computing device and the controller 112 may be a direct link, such as via the PAN communications systems 116, 144C of the smart-structure 104 and the personal mobile computing device, respectively. For example, if the PAN communications link is provided via BLE technology, then the communications link will be a BLE communications link. That said, if/as needed, the communications link may be an indirect links, such as via the WLAN communications systems 120, 144D or the cellular network radios 124, 144E. When the person within the securable occupiable space 104A is controlling a controllable environmental system via one or more control interfaces 148C of SOS network portal 148, for example, via the browser 144B on the personal mobile computing device 144, the communications link between the personal mobile computing device and the controller 112 may be an indirect links, such as via the WLAN communications systems 120, 144D or the cellular network radios 124, 144E. When the person within the securable occupiable space 104A is controlling a controllable environmental system via one or more control interfaces 168 provided directly by the smart-structure 104, the communications link between the control interface(s) and the controller 112 may be a direct wired link or a direct wireless link. In an example of the latter, the wireless link may use the PAN communications system 116 of the smart-structure 104, among others.

Just as when the controller uses the occupancy signal 140A when indicating that the person is present within the securable occupiable space 104A to provide the person with control of, for example, the one or more controllable environmental systems 128, at optional block 240 (FIG. 2) the controller may rescind the control provided to the person so that the person can no longer control the controllable environmental system(s). As those skilled in the art will appreciate, the controller 112 may effect the rescission of control in any suitable manner, such as by essentially reversing the manner in which it provided the control in the first place. In an alternative in which a use session of the securable occupiable space has a predetermined length of time, the controller 112 may use the initial person-present state of the occupancy signal 140A to start a use-session timer (not shown) that times the use session. Then, when the use-session timer times out, indicating the end of the use session, the controller may automatically rescind control from the person in any manner suitable to the control interface(s) 144A(C), 148C, and 168 at issue.

Another example of providing control to a person now located within the securable occupiable space 104A, the mechanical privacy deadbolt lock 104D, which could be configured like the privacy deadbolt lock 332 of FIG. 3, can be replaced with an electronic/virtual deadbolt lock incorporated, for example, into electronic lock 104C and actuatable by the person via, for example, any one or more of the SOS app 144A, the SOS network portal 148, or an interface device (not shown) that is part of the smart-structure 104. For example, the electronic lock 104C may include two electronically activated locks, an access control lock and a privacy deadbolt lock (not separately shown). The access control lock may be actuatable by the controller in the manner discussed above relative to allowing the person initial access to the unoccupied securable occupiable space 104A when the person (their personal mobile computing device 144) is located proximate to the securable occupiable space. However, the privacy deadbolt lock may only be actuatable once the occupancy signal 140A has indicated to the controller 112 that the person is located in the securable occupiable space 104A.

For example, the SOS app 144A and/or the SOS network portal 148 may be provided with a deadbolt lock soft control 144A(D), 148D, respectively, that is grayed out until the controller activates the deadbolt lock soft control based on the occupancy signal 140A indicating that the person (the personal mobile computing device 144) being present within the securable occupiable space 104A. In response to receiving such a person-present occupancy signal 140A, the controller 112 may cause the grayed-out deadbolt lock soft control 144A(D), 148D to become active (non-grayed out signal causing) so that the person can engage the electronic privacy deadbolt of the electronic lock 104C. When the occupant actuates the deadbolt lock soft control 144A(D), 148D, a corresponding lock-deadbolt signal (not shown) may be sent to the controller 112. In response to receiving such lock-deadbolt signal, the controller 112 may generate and send a corresponding activate-deadbolt signal (not shown) to the electronic lock 104C, which causes the electronic lock to actuate the privacy deadbolt lock.

In some embodiments, a use session may continue as long as the person within the securable occupiable space 104A desires to remain there. Correspondingly, the controller 112 may keep control of the electronic privacy deadbolt lock available to the person until they disengage the electronic privacy deadbolt lock. In some embodiments, a use session may continue for a predetermined amount of time. In such embodiments, once the controller 112 determines that the use session has ended, it may automatically disengage the electronic privacy deadbolt lock and, perhaps, notify the person that it is time for them to exit the securable occupiable space 104A. In some embodiments, the controller 112 may notify the person that the use session is going to end in some predetermined amount of time as a warning. A variety of other end-of-use-session indications or notifications are possible. In some embodiments, such end-of-use-session indications or notifications may be performed directly using the PAN communications systems 116, 144C and/or indirectly using the WLAN communications systems 120, 144D and/or cellular network radios 124, 144E, among others.

In some embodiments, the controller 112 may include one or more timers (not shown) for delaying taking certain actions. For example, the controller 112 may utilize an exit timer (not shown) that may keep one or more of the controllable environmental systems 128 operating with the parameter(s) set by the person when they had control for a set amount of time after the controller detects a change in the occupancy signal 140A. This may be useful, for example, if the occupancy signal 140A is of a nature that it does not truly detect occupancy in the strictest sense, such as when the occupancy signal is based on the actuation of a privacy deadbolt lock, such as the mechanical privacy deadbolt lock 104D or an electronic privacy deadbolt lock, each of which the occupant must actuate while still inside the securable occupiable space 104A. Using an exit timer, for example, gives the person time to collect belongings and exit the securable occupiable space 104A.

In some embodiments, the controller 112 may include an entrance timer (not shown) that may give the person time to enter the securable occupiable space 104A and get settled therein before taking an action. For example, the controller 112 may operate an entrance timer that the controller stops if it receives a signal (e.g., an occupancy signal 140A via a privacy deadbolt lock) that indicates the person has taken an affirmative action relative to their use session. If the entrance timer expires before receiving such a signal, the controller 112 may cause the person to be notified that they should take some action, such as actuating a privacy deadbolt lock (e.g., the mechanical privacy deadbolt lock 104D or an electronic privacy deadbolt lock of the electronic lock 104C, if so equipped). The controller 112 may effect such notification in any suitable manner, such as via SOS app 144A, via SOS network portal 148, or a display device of the smart-structure 104 itself. The mode of effecting the notification may be, for example, directly using the PAN communications systems 116, 144C and/or indirectly using the WLAN communications systems 120, 144D and/or cellular network radios 124, 144E, among others.

While the present examples herein are described in terms of the controller 112 providing the occupant with the previously unavailable ability to control one or more of the controllable environmental systems 128, those skilled in the art will understand that the decision-making and/or providing of such control may be performed by another computing system, such as a computing system aboard the one or more remote servers 132.

Nursing Pod Example

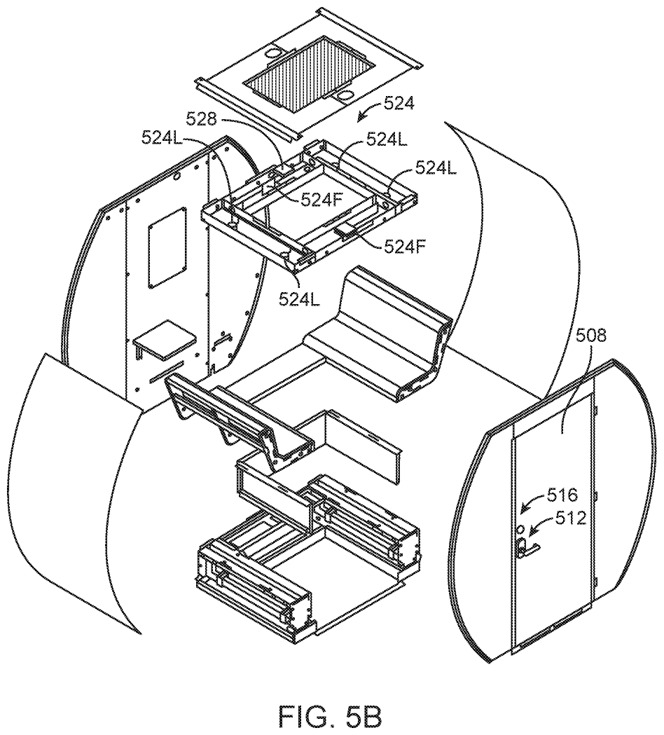

For general context of this example, FIGS. 5A and 5B illustrate an example smart-structure in the form of a nursing pod 500 made in accordance with various aspects of the present disclosure. In this example, the nursing pod 500 includes a securable occupiable space 504 to which a person can retreat for privacy while nursing or pumping breast milk. The securable occupiable space 504 is accessible via a door 508 (securable closure) (FIG. 5B) having an electronic lock 512 and deadbolt system 516 for secure privacy while the occupant (not shown) (i.e., the person carrying a personal mobile computing device 520 (FIG. 5A) that is inside the securable occupiable space) is in the securable occupiable space. In this example, the nursing pod 500 is provided with the following controllable environmental systems 524 (FIG. 5B): a ventilation-fan system having one or more variable-speed ventilation fans 524F, a lighting system having a plurality of dimmable luminaires 524L, and an audio system (not shown, but incorporated into a central pod control device (PCD) 528) having user-selectable music and/or sounds, and user-controllable audio settings, such as volume. When the nursing pod 500 passes control of these controllable environmental systems 524 to the occupant, in this example the occupant can control the speed of the ventilation fans 524F to control air flow, control the amount of light emitted from the luminaires 524L, make audio content selections, and control the volume of the audio output. Again, these controllable environmental systems 524 are merely examples, and they are not to be construed as limiting in any manner.

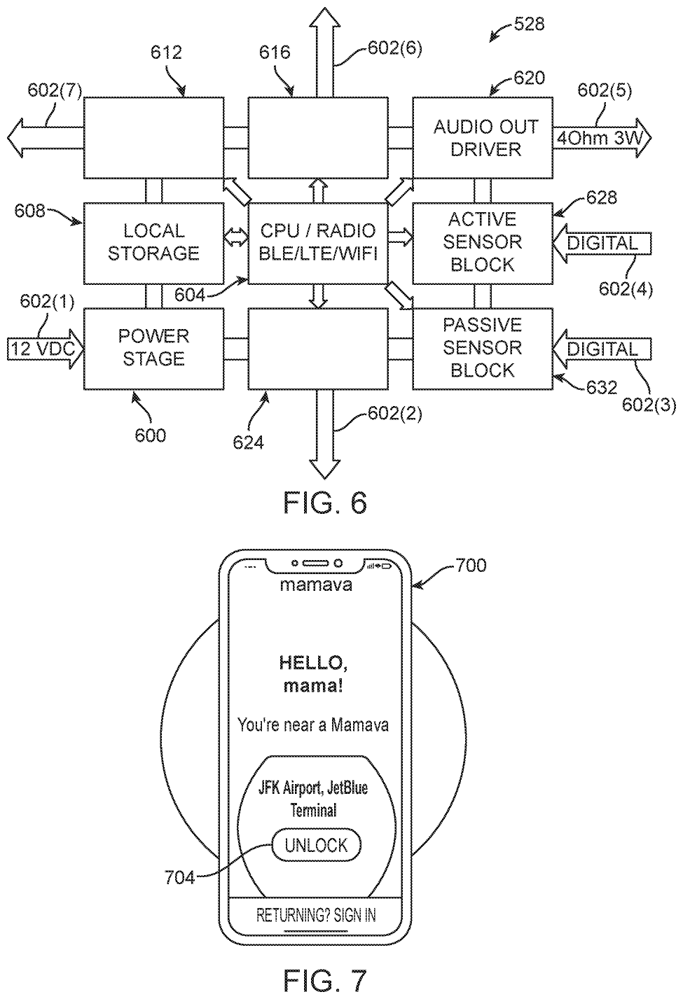

In this example, the nursing pod 500 is controlled by the PCD 528 that provides all of the communications and control functionalities of the nursing pod. In some embodiments, all of the systems, including the electronic lock 512 and deadbolt system 516, ventilation-fan system, lighting system, and audio system are designed so that their components can all operate off of the same power supply (here, a 12V power supply) (power stage 600, FIG. 6) provided by the PCD 528 and have power and/or control connectors (illustrated as arrows 602(1) to 602(7) of FIG. 6) that plug, in a plug-and-play fashion, into mating connectors (not shown) of wiring emanating from the PCD. These features allow for simple and efficient assembly of the nursing pod 500.

Referring to FIG. 6, in this example PCD 528 has a motherboard 604 that includes a central processing unit (CPU) and three types of communication devices, here a BLE radio (for providing a PAN to communicate with nearby personal mobile computing devices of users and others, such as service personnel), a Wi-Fi radio (for providing a WLAN to communicate, e.g., with cloud-based services (not shown) via a WLAN (not shown)), and a cellular communication (LTE in this example) radio (e.g., for communicating with cloud-based services), all of which are not independently labeled in FIG. 6. In some embodiments, communication with cloud-based services is preferred to occur via the cellular communication radio because of the publicness of cellular systems. However, it is recognized that in some circumstances communicating with cloud-based services may need to occur using the Wi-Fi radio, which may require registration to a private Wi-Fi network (not shown). Examples of cloud-based services include data collection for uploading data (such as occupancy, systems performance, user-set settings, and usage) from the nursing pod 500 (FIGS. 5A, 5B) to the cloud, firmware updating, remote maintenance and/or troubleshooting, advertising (e.g., pushed to users), and remote unlocking, among others. It is noted that the BLE radio can be replaced by another short-range, i.e., PAN, communication radio or other technology (e.g., infrared), the LTE radio can be replaced by another cellular communication radio (e.g., 5G), and the Wi-Fi radio can be replaced by another type of radio or other WLAN technology (e.g., Li-Fi).

Example PCD 528 also includes a local storage 608 (part of the overall memory of PCD, which may also include other memory, such as RAM and cache memories of the CPU, among others) that contains, among other things, audio content and all of the information and machine-executable instructions that the CPU aboard the motherboard 604 executes to provide the nursing pod 500 (FIGS. 5A, 5B) with all of the functionalities described herein, including, but not limited to, lighting-control functionality (via “LED” control block 612), fan-control functionality (via fan control block 616), audio content selection and audio control functionalities (via audio out driver 620), lock-control functionality (via lock control block 624), sensing functionalities (such as deadbolt position sensing, power usage sensing (for electrical outlets, USB charging ports, etc.)) (via active sensing and passive sensing blocks 628, 632), communications functionalities (here, BLE, Wi-Fi, LTE), functionalities for passing environmental systems control to occupants, and data-collection functionalities, among others. In this example and as noted above, the PCD 528 is powered by a 12 V DC power stage 600 that provides the power to all of the components aboard the PCD. As indicated above, the PCD 528 in this example contains all of the components shown in FIG. 6 in a single plug-and-play unit for ease of construction of the nursing pod 500 (FIGS. 5A and 5B) and the ease of modifying and/or repairing such a nursing pod.

Example Nursing Pod Deployment and Usage Scenarios

This section describes example deployment and usage scenarios for a nursing pod made in accordance with the present disclosure, such as the nursing pod 500 of FIGS. 5A and 5B mentioned above. In this example, a pod provider provides nursing pods to customers desiring to have one or more nursing pods at a particular customer facility or other location. For example, an international airport may contract with the pod provider to provide two nursing pods for each of a plurality of concourses at the airport. In this example, the entire airport has access to LTE cellular service and provides a private Wi-Fi network. Each nursing pod may be provided with a SIM card that allows the PCD of the nursing pod to connect as needed to the LTE cellular network. In some embodiments, the SIM cards may be agnostic relative to carriers and/or national/regional networks and may simply allow for connection to the carrier that provides the greatest signal strength at the nursing pod location under consideration. In this case, the airport allows the pod provider to connect the PCD of each nursing pod to its private Wi-Fi network as backup to the cellular connection, and a technician enters the appropriate credentials in the PCD for connecting to the airport's private Wi-Fi network.

The pod provider maintains cloud-based services (see, e.g., remote server(s) 132 of FIG. 1) for all of the nursing pods it deploys in the field to its various customers. The pod provider also provides an SOS app (see, e.g., SOS app 144A of FIG. 1), such as through Google Play Apps and/or the Apple App Store, that any prospective occupant (person) of one or more of the nursing pods provided by that pod provider can download to their personal mobile computing device to access a nursing pod. In some embodiments, the pod provider may require each user to register themselves via the SOS app to utilize its nursing pods/pod network, including, as appropriate or desired, providing credit/debit card information for automatic payment and/or user verification. One service that the pod provider may provide via the SOS app is mapping functionality that displays, to a prospective occupant, locations of its nursing pods. In some embodiments, no payment information is required, and the SOS app is free. For example, all that is needed is a name and an email to sign-up. In some embodiments, when the SOS app and/or cloud services (e.g., aboard one or more remote servers, such as remote server(s) 132 of FIG. 1 and/or SOS network portal 148) recognizes that the prospective occupant (i.e., their personal mobile computing device) is close to one of the nursing pods, say within 200 meters as a nonlimiting example, the SOS app may display the occupancy status of that nursing pod to the prospective occupant. The occupancy status may either be obtained through the local BLE connection which is limited to some distance less than 200 m. Alternatively, the occupancy may be obtained from the cloud services if the pod has previously updated the cloud services with status information. In some embodiments, the SOS app may also provide locations of other lactation spaces that are not from the pod provider but that have been approved by the pod provider.

If the nursing pod is unoccupied and the prospective occupant decides to use that nursing pod, the prospective occupant moves close to that nursing pod. At this point, the electronic access-control lock on the door of the nursing pod is engaged (locked) so that only an authorized user can enter the pod. When the personal mobile computing device of the prospective occupant is within communication range of the BLE radio aboard the unoccupied nursing pod and the BLE radio on the prospective occupant's personal mobile computing device is turned on, in response to the SOS app scanning for the BLE signal of the nursing pod, the SOS app may display on a popup screen 700 (see FIG. 7) an available status of the given nursing pod and presents an unlock soft button 704 to the prospective occupant. For example, the homescreen of the SOS app may display nearby nursing pods in a carousel format and show the status as a banner at the bottom of the carousel. When the prospective occupant is close enough to the nursing pod, the SOS app changes the status to the soft button 704 (FIG. 7) for unlocking. If the prospective occupant decides then to use the nursing pod, she selects the unlock soft button 704 (FIG. 7), which causes the PCD to 1) establish that the prospective occupant's personal mobile computing device is the device that it should be paired to for subsequent communications (such as for environmental control) (this can occur, e.g., using the BLE device's MAC address, among other things), 2) unlock the door to the nursing pod to allow the prospective user to enter the securable occupiable space and become a user, and 3) start a timer (e.g., a 30-second timer) that causes the PCD controller to turn on the lights and fans before the user has locked the deadbolt to start the session. It is noted that had the nursing pod been occupied, the BLE communication between the PCD of the lactation pod and the prospective occupant's personal mobile computing device would have caused the SOS app to display a pod-occupied screen without the unlock soft button 704 (FIG. 7).

Once the occupant is in the securable occupiable space within the nursing pod, the SOS app and/or signage within the nursing pod may instruct the user to engage the privacy deadbolt lock. In this embodiment, the privacy deadbolt lock includes an electrical switch that is open when the privacy deadbolt lock is not engaged and closed when the privacy deadbolt lock is engaged. When the user engages the privacy deadbolt lock, the closing of the switch signals the PCD that the user is occupying and secured within the securable occupiable space and is ready for their nursing and/or pumping session to begin. The PCD uses this deadbolt engagement signal (equivalent to the occupancy signal 140A of FIG. 1) to effectively turn control of the controllable environmental systems over to the occupant.

In this example, the SOS app on the user's personal mobile computing device includes an environmental-control GUI (see, e.g., the control GUI 400 of FIGS. 4A and 4B as a simple example), and the deadbolt engagement signal causes this environmental-control GUI to become activated, i.e., the user act of engaging causes the PCD to allow user inputs to the environmental-control GUI to control the corresponding respective lighting, ventilation, and audio systems. This activation of environmental control functionality can be achieved in any of a variety of ways. For example, before the user engages the privacy deadbolt lock, the SOS app may display, for example, on the user's personal mobile computing device, one or more environmental-control icons for providing environmental soft controls, but with the icons “grayed-out,” meaning that the user cannot currently select any of them. Then, in response to the PCD receiving the deadbolt engaged signal, the PCD may send via the BLE radio a signal to the SOS app to unlock the environmental-control icon(s) that allows the user to select them to provide the corresponding respective environmental soft controls.

As another example, the SOS app may display, for example, on the user's personal mobile computing device, one or more environmental-control icons and/or one or more environmental soft controls as if they are selectable and/or usable. However, until the user engages the privacy deadbolt lock to create the deadbolt engagement, or occupancy, signal, the PCD may simply not recognize or act upon any inputs the user provides via such environmental soft controls. In this example, the SOS app may display a notice to the user, such as “Environmental Controls Not Active Until You Engage the Deadbolt”, or something to that general effect. Then, in response to the user engaging the deadbolt and closing the deadbolt switch to cause the occupancy signal, the PCD will send an activate-controls signal via the BLE radio to the SOS app that causes the SOS app to activate the environmental soft controls. These are just a few examples of how the PCD may pass, or provide, control of the controllable environmental systems of the nursing pod to the occupant in the securable occupiable space of the nursing pod. With guidance from this disclosure, those skilled in the art will be able to develop alternative ways of passing or providing such controls to the occupant without undue experimentation.

It is noted that the forgoing example of passing/providing control of the onboard controllable environmental systems to the occupant within the securable occupiable space is one of several alternatives. In other embodiments and as discussed above in connection with other embodiments, the triggering event may not be the engagement of a privacy deadbolt lock. For example, the securable occupiable space may be monitored by one or more occupancy sensors, such as a motion sensor, vision sensor, pressure sensor, and/or thermal sensor, among others. In one particular example, the door to the nursing pod may be monitored by a door-closed sensor that indicates when the door is fully closed, and the securable occupiable space may be monitored by a thermal sensor. In this example, the PCD may be programmed to pass control of the onboard controllable environmental systems when it determines that the door is fully closed and the thermal senor senses a person's body heat in the securable occupiable space. Other criteria for establishing when the PCD should pass, or otherwise provide, control to the occupant can be used in other embodiments. It is noted that the set of electrical contacts 328 of FIG. 3 and the power to the electronic lock 304 passing therethrough when the door of the nursing pod is fully closed can be used as part of a door-closed sensor system.

As an example of a door-closed sensor, the nursing pod may include the electronic lock 304, wiring 320 and set of electrical contacts 328 of FIG. 3, and the PCD may be configured to sense when power is and is not flowing through the wiring that contains the set of electrical contacts. When the PCD senses that the power is flowing through the wiring 320, it may infer that the set of electrical contacts 328 are engaged with one another and that, therefore, the door is closed. Conversely, when the PCD senses that the power is not flowing through the wiring 320, it may infer that the set of electrical contacts 328 are not engaged with one another and that, therefore, the door is open. In other embodiments, if the nursing pod is provided with a door-closed sensor, it can be another type of sensor, such as a dedicated switch or other type of sensor.

The soft controls (see, e.g., the soft controls of FIGS. 4A and 4B as a general example) provided by an SOS app for allowing the user to control the controllable systems onboard the nursing pod can be any suitable soft controls. For example, for controlling the lighting system, the environmental-control GUI may provide one or more soft sliders, soft knobs, or soft radio buttons, among other soft controls, for changing the intensity of the light output by the luminaires. Similarly, for controlling the ventilation system, the environmental-control GUI may provide one or more soft sliders, soft knobs, or soft radio buttons, among other soft controls, for changing the speed(s) of the ventilation fan(s). For controlling the audio system, the environmental-control GUI may provide one or more soft sliders or soft knobs to adjust the volume, tone, balance, fade, etc., of the audio system and may provide a content selection GUI that allows the user to select the audio file(s) to be played and, perhaps, the order in which the PCD will play them. Those skilled in the art will understand how to configure soft controls for the environmental-control GUI of an SOS app to allow a user to appropriately control the environmental system(s) onboard any particular pod. FIG. 7 illustrates an example screen of an environmental-control GUI 700 that allows the user to adjust the lighting and airflow provided, respectively, by the lighting system and ventilation system.

While the occupant remains within the securable occupied space, she can use the environmental-control GUI to adjust any one or more of the adjustable parameters of the environmental systems as desired. The SOS app generates corresponding control signals and causes the occupant's personal mobile computing device to send such control signals via the BLE connection to the PCD. In response to the PCD receiving the control signals, it controls the corresponding environmental system(s) accordingly.

When the occupant is done with her session, she disengages the deadbolt, which causes the deadbolt switch to open. The PCD senses the opening of the deadbolt switch as an occupancy signal, and, in response to receiving this deadbolt-disengaged signal, rescinds the ability of the SOS app, and therefore the occupant, to control the controllable environmental systems. Depending on how the SOS app and/or the PCD are configured, this rescission of control may take any of a variety of forms. For example, relative to the examples of passing control described above, the rescission of control may proceed in the opposite manner. For example, if the passing of control caused inactive icons and/or soft controls to become active, the rescission of control may cause active icons and/or soft controls to be deactivated.

In some embodiments, the PCD may respond to the deadbolt-disengaged, or occupancy, signal by changing various parameter settings of the controllable environmental systems to default settings. This can be desirable, for example, if the occupant that just finished her session changes one or more settings in a way that might be offensive to the next occupant. By the PCD setting such parameters to innocuous “default” settings, the next occupant will not be subjected to the possibly extreme setting(s) of the previous occupant. As an example, a previous occupant may have turned the luminaires and fan(s) up to their maximum levels, which might be offensive to the next occupant. By returning the lighting and ventilation parameters to more pleasant default settings, the next occupant will not be offended. In some embodiments, the PCD will not set the environmental parameters to their default settings immediately upon receiving the deadbolt-disengaged signal. Rather, the PCD may wait for a predetermined period of time (e.g., 30 seconds) before changing the parameters to their default settings. This gives the occupant time to exit the securable occupiable space before the PCD implements the changes. As with the deadbolt-engaged signal, the deadbolt-disengaged signal can be replaced by one or more other occupancy signals, such as a motion-detector signal, a thermal-detector signal, and/or a door-closed signal. For example, the PCD may determine via a motion sensor and a door-closed sensor that the occupant has exited the nursing pod and has firmly shut the door behind them when leaving. The PCD may use the combination of these two states to change the environmental parameters to their default settings.

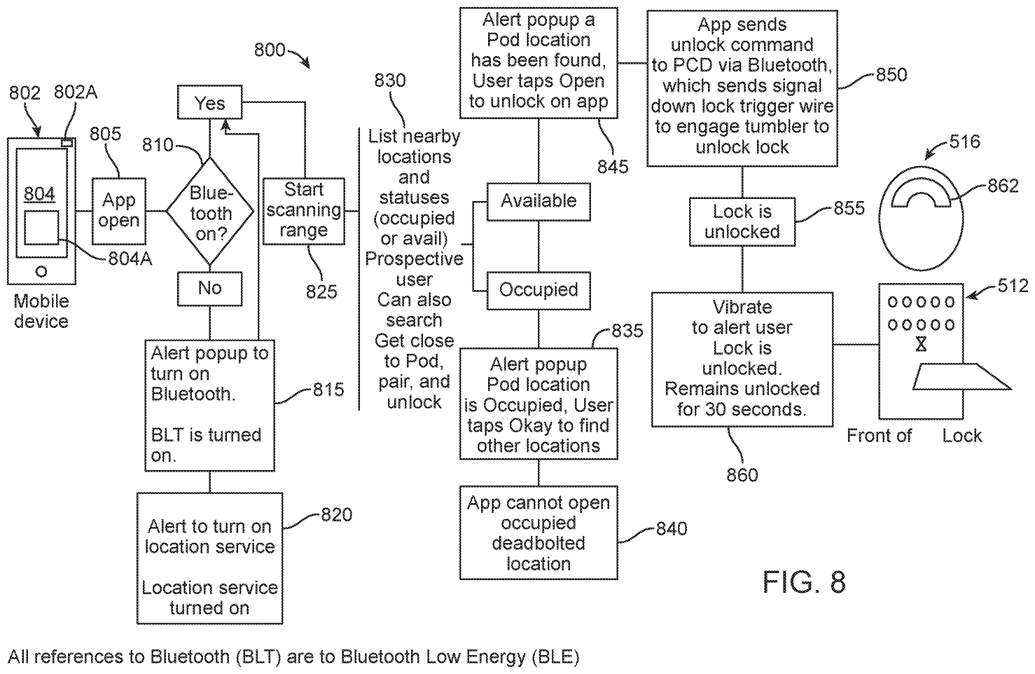

Referring to FIG. 8, and also to FIGS. 5A, 5B as noted, FIG. 8 illustrates an example method 800 of how a prospective occupant can gain access to the securable occupiable space 504 (FIGS. 5A, 5B) within the nursing pod 500 (FIGS. 5A, 5B) via her personal mobile computing device 802 and using a corresponding pod, or SOS app 804. At block 805, the SOS app 804 is open and running on the personal mobile computing device 802. At block 810, the SOS app 804 determines whether or not the BLE radio 802A aboard the personal mobile computing device 802 is turned on and available to connect with the BLE radio (not shown, but see FIG. 6) of the PCD 528 (FIGS. 5A, 5B) of the target nursing pod 500. If not, at block 815 the SOS app 804 may display an alert on the personal mobile computing device 802 notifying the prospective occupant to turn on the BLE radio 802A, and the prospective occupant turns on the BLE radio. If the location services (not shown) of the personal mobile computing device 802 are not turned on, at block 820 the SOS app 804 may display an alert on the personal mobile computing device 802 notifying the prospective occupant to turn on location services. When the BLE radio 802A is on, at block 825 it scans for other BLE radios within range, such as the BLE radio of the PCD 528.

At block 830, the SOS app 804 displays on the personal mobile computing device 802 a list of nearby nursing pods and their corresponding respective occupancy statuses (e.g., occupied, available). Also at block 830 the prospective occupant can search for other nursing pods that may be in the general vicinity by not within the range of the BLE radio 802A. In this case, the SOS app 804 may use another radio (not shown, but such as an LTE (cellular network) radio or a Wi-Fi (WLAN) radio) aboard the personal mobile computing device 802 if the data regarding other locations is stored offboard the personal mobile computing device. Further at block 830, the prospective occupant may select a nearby nursing pod and move close to it.

If a nearby nursing pod, here nursing pod 500, is occupied, at block 835 the SOS app 804 may display on the personal mobile computing device 802 an alert (e.g., via a popup window) (not shown) notifying the prospective occupant that that corresponding nursing pod 500 is occupied and may ask the prospective occupant if she wants to locate another nursing pod that is available or that may soon be available (e.g., based on data collected on a current occupancy and, perhaps, also statistical or other information). If the prospective occupant wants to locate another nursing pod, she may select an “Okay” or other soft control (not shown), which may cause the SOS app 804 to initiate a corresponding search and mapping process. At block 840 it is noted that the SOS app 804 cannot open a deadbolted securable occupiable space because that deadbolting by a current occupant is an indication that the current occupant is to have complete privacy.

If the nearby nursing pod 500 is available, at block 845 the SOS app 804 may display on the personal mobile computing device 802 an alert (e.g., via a popup window) (not shown) notifying the prospective occupant that that corresponding nursing pod 500 is available and providing a “Open”, “Unlock”, or similar soft control (not shown). If the prospective occupant desires to use the nearby nursing pod 500, she may tap or otherwise select the “Open” soft control. In response to this selection, at block 850 the PCD 528 (FIGS. 5A, 5B) may send an unlock command signal to the electronic lock 512 to unlock the access-control lock of the electronic lock to allow that prospective occupant to open the door 508 (FIGS. 5A, 5B) and enter the securable occupiable space 504 (FIGS. 5A, 5B). In one example, the SOS app 804 may send an unlock command (not shown) to the PCD 528 via the BLE radio 802A. Other manners of unlocking the electronic lock 512 may be employed as desired. At block 855, the electronic lock 512 is in an unlocked state.

At block 860, the SOS app 804 may alert the prospective occupant that the electronic lock 512 is now unlocked and/or that they may now enter the securable occupiable space 504 (FIGS. 5A, 5B). Such an alert may take any one or more of a variety of forms, such as a visual message displayed on the personal mobile computing device 802 and/or causing the personal mobile computing device to vibrate. In the present example, the PCD 528 (FIGS. 5A, 5B) keeps the electronic lock 512 unlocked for 30 seconds to give the prospective occupant time to get into the securable occupiable space 504. The SOS app 804 may display a timer (not shown) on the personal mobile computing device 802 that shows the time remaining until the PCD 528 (FIGS. 5A, 5B) relocks the electronic lock 512. FIG. 8 also shows the exterior of an example privacy deadbolt lock 862 of the privacy deadbolt system 516 of FIGS. 5A and 5B.

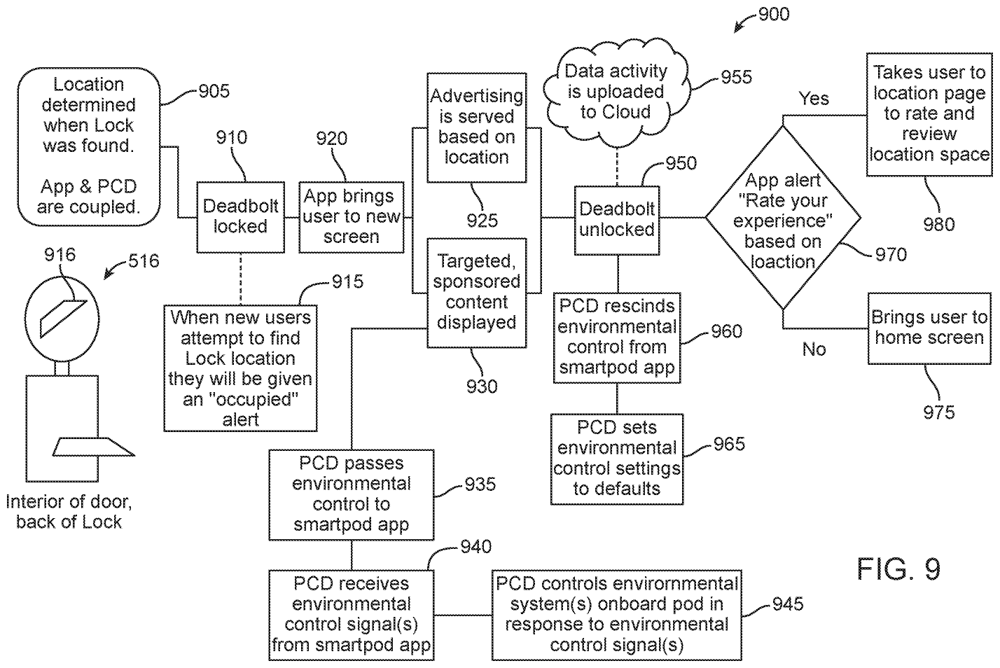

FIG. 9 illustrates an example method 900 of an occupant of a securable occupiable space, such as the securable occupiable space 504 of nursing pod 500 of FIGS. 5A and 5B, interacting with a controller, such as the PCD 528 of FIGS. 5A and 5B. Referring now to FIG. 9, and also occasionally to FIGS. 5A and 5B and FIG. 8 as noted for context, block 905 of method 900 indicates that the PCD 528 (FIGS. 5A, 5B) of the nursing pod 500 is coupled with the SOS app 804 (FIG. 8) aboard the personal mobile computing device 802 (FIG. 8), here via the corresponding respective BLE radios (802A of the personal mobile computing device 802). Block 910 indicates that the occupant is present within the securable occupiable space 504 (FIGS. 5A, 5B) and has activated the privacy deadbolt system 516. The occupant's locking of the privacy deadbolt system 516 (FIGS. 5A, 5B), here via a rotary deadbolt 916 and corresponding switch (not seen), generates an occupancy signal (not shown). In response to receiving the occupancy signal, the PCD 528 (FIGS. 5A, 5B) generates an occupied signal and transmits the occupied signal via the BLE radio (not shown) aboard the PCD 528. When a new prospective occupant is within range of the BLE radio aboard the PCD 528 (FIGS. 5A, 5B), the BLE radio (not shown) of the corresponding personal mobile computing device (not shown) receives the occupied signal. Correspondingly, the SOS app (not shown) of that other personal mobile computing device causes the personal mobile computing device to display at block 915 an “Occupied” or similar alert to the new prospective occupant, letting them know that the securable occupiable space 504 (FIGS. 5A, 5B) is not available. The PCD 528 (FIGS. 5A, 5B) may also transmit the occupied signal via one or both of the Wi-Fi and LTE radios, for example, to one or more remote servers (such as remote servers 132 of FIG. 1) for logging and/or other purposes.

In response to receiving the occupancy signal from the privacy deadbolt system 512, the PCD 528 (FIGS. 5A, 5B) may cause, at block 920, the PCD 528 (FIGS. 5A, 5B) to send a command/signal (e.g., via BLE radio 802A (FIG. 8)) to the personal mobile computing device 802 (FIG. 8) of the occupant that causes the SOS app 804 to display on the personal mobile computing device a new screen (not shown) to the occupant. At block 925, the PCD 528 (FIGS. 5A, 5B) may optionally serve location-based advertising (not shown) to the SOS app 804 (FIG. 8) for display on the personal mobile computing device 802 (FIG. 8), for example, on the new screen of block 920. Additionally, alternatively, or optionally, at block 930, the PCD 528 (FIGS. 5A, 5B) may optionally serve targeted, sponsored content (not shown) to the SOS app 804 (FIG. 8) for display on the personal mobile computing device 802 (FIG. 8), for example, on the new screen of block 920.

In response to receiving the occupancy signal from the privacy deadbolt system 512, the PCD 528 (FIGS. 5A, 5B) may cause, at block 935, the PCD 528 (FIGS. 5A, 5B) to send a command/signal (e.g., via BLE radio 802A (FIG. 8)) to the personal mobile computing device 802 (FIG. 8) of the occupant that causes the SOS app 804 to allow the occupant to control the controllable environmental systems 524 (FIGS. 5A, 5B) via the personal mobile computing device, such as via one or more control GUIs 804A (FIG. 8). Nonlimiting examples of control GUIs suitable for the control GUIs 804A (FIG. 8) of the personal mobile computing device 802 (FIG. 8) are illustrated in FIGS. 4A and 4B. In response to the occupant making a change to at least one environmental parameter (e.g., temperature, fan speed, lighting level, audio volume level, song selection, etc.) via the control GUI(s) 804A (FIG. 8), the SOS app 804 (FIG. 8) may send one or more corresponding environmental control signals (not shown) via the BLE radio 802A (FIG. 8), which the PCD 528 (FIGS. 5A, 5B) receives at block 940. At block 945, in response to receiving the environmental control signals from the personal mobile computing device 802 (FIG. 8) the PCD 528 (FIGS. 5A, 5B) controls each of the one or more controllable environmental systems 524 (FIGS. 5A, 5B) according to the parameter(s)/parameter value(s) that the occupant has selected. This control can be effected in any suitable manner, such as manners known in the art for controlling environmental systems via a central processor, among others. In this example, the occupant's ability to control the environmental systems 524 (FIGS. 5A, 5B) remains until the occupant unlocks the privacy deadbolt system 516.

At block 950, the occupant has unlocked the privacy deadbolt lock system 516, which provides a second occupancy signal (not shown) that effectively indicates to the PCD 528 (FIGS. 5A, 5B) that the occupant is ending her use session. In response to receiving this second occupancy signal, at block 955 the PCD 528 (FIGS. 5A, 5B) may upload activity data to the “cloud,” such as to one or more remote servers (e.g., remote server(s) 132 of FIG. 1). Such activity data may include, but not be limited to, information identifying the occupant, controllable environmental system settings, time stamps of locking and unlocking the privacy deadbolt lock system 516, the health status of the various systems aboard the nursing pod 500 (FIGS. 5A, 5B), and/or the advertisements and/or targeted content provided to the occupant, among other data. Also in response to receiving the secondary occupancy signal, at block 960 the PCD 528 (FIGS. 5A, 5B) may rescind the ability of the occupant to control the controllable environmental systems 524 (FIGS. 5A, 5B), for example, by transmitting a suitable rescind control signal (not shown) to the personal mobile computing device 802 (FIG. 8) via the BLE radio 802A (FIG. 8). In addition, at block 965, the PCD 528 (FIGS. 5A, 5B) may set environmental control settings of the controllable environmental systems 524 (FIGS. 5A, 5B) to suitable default settings that the PCD may maintain when the nursing pod 500 (FIGS. 5A, 5B) is unoccupied. In some embodiments, in lieu of immediately setting environmental control settings to default settings up receiving the second occupancy signal, the PCD 528 (FIGS. 5A, 5B) may set an egress timer (not shown) that delays the setting of the environmental control settings to the default settings for a predetermined amount of time, such as, for example, 45 seconds, to give the time for the occupant to exit the securable occupiable space 504 (FIGS. 5A, 5B).

In some embodiments, the receiving of the second occupancy signal from the occupant's unlocking of the privacy deadbolt lock system 516 may cause the PCD 528 (FIGS. 5A, 5B) to send a signal (not shown) to the SOS app 804 (FIG. 8) (e.g., via the BLE radio 802A (FIG. 8)) to cause, at block 970, the SOS app to display an alert on the personal mobile computing device 802 (FIG. 8) that notifies the occupant/former occupant of the opportunity to rate their experience via the SOS app and displays one or more “Rate your experience” soft controls (not shown), such as a “Rate it” soft control and a “No thanks” soft control. In this example, if the occupant/former occupant selects the “No thanks” soft control, at block 975 the SOS app 804 (FIG. 8) may display a homescreen or other screen (not shown) on the personal mobile computing device 802 (FIG. 8). However, if the occupant/former occupant selects the “Rate it” soft control, the SOS app 804 (FIG. 8) may display a location page (not shown) on the personal mobile computing device 802 (FIG. 8) corresponding to the current nursing pod 500 (FIGS. 5A, 5B) that the occupant/former occupant can use to rate her experience with that nursing pod. This location page can be used to allow the occupant/former occupant to leave a message for the next occupant, such as the message 400D(M) described above in connection with FIGS. 4A and 4B that the system may then display to the next occupant, such as in the message region 400D of the local-SOS GUI 400 of FIGS. 4A and 4B.

Those skilled in the art will readily appreciate that the foregoing methods 800 and 900 of FIGS. 8 and 9, respectively, are merely exemplary of many alternative methods that perform at least some of the same or similar functionalities. Those skilled in the art will also readily understand how the various blocks illustrated may be modified, eliminated, combined with other blocks, modified, and/or performed in a different order to achieve desirable results.

It is noted that any one or more of the features, functionalities, and aspects described herein relative to the nursing pods, such as nursing pod 500 of FIG. 5, may be incorporated into another smart-structure made in accordance with the present disclosure, such as smart-structure 104 of FIG. 1 as an example. Those skilled in the art will understand how to make any necessary change(s) and/or adaptation(s) to make such incorporation(s) such that further explanation is not necessary for those skilled in the art to practice the present inventions to their fullest scope.

Example Computing System

Any one or more of the aspects, features, functionalities, and/or embodiments described herein may be conveniently implemented using one or more computing systems (e.g., servers, controllers, personal mobile computing devices, etc.) that are programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software (e.g., machine-executable instructions), software applications (apps), and/or software modules or other code segments collections may also include appropriate hardware (e.g., servers, controllers, personal mobile computing devices, etc.) for assisting in the implementation of the machine-executable instructions of the software and/or software module.

Such software may be embodied in a computer program product that employs a machine-readable storage medium. A machine-readable storage medium may be any medium that is capable of storing and/or encoding a sequence of instructions for execution by a machine (e.g., a computing device or computing system) and that causes the machine to perform any one of the methodologies, functionalities, aspects, and/or embodiments, or portion(s) thereof, described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk or solid-state drives in combination with a computer-based memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

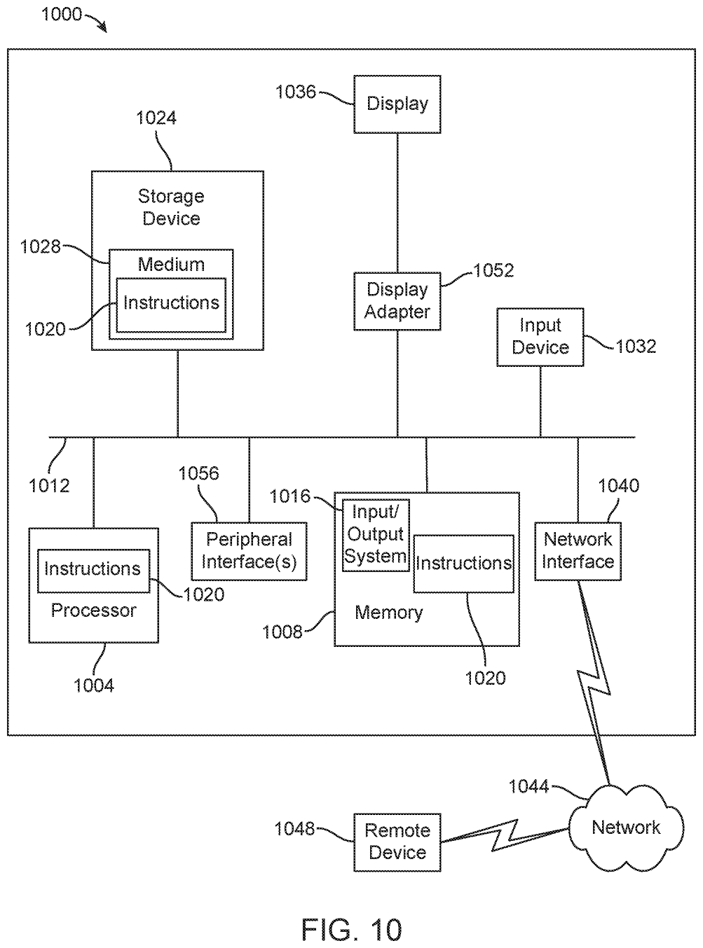

FIG. 10 shows a diagrammatic representation of one embodiment of a computing device in the exemplary form of a computer system 1000 within which a set of instructions for causing a central PCD to perform any one or more of the aspects and/or methodologies of the present disclosure may be executed. It is also contemplated that each of multiple personal mobile computing devices may be utilized to implement a specially configured set of instructions for causing one or more of the PCDs to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Memory 1008 may include various components (e.g., machine-readable media) including, but not limited to, a random access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A method, performed by a controller of a smart-structure having a securable occupiable space having an access lock for preventing access to the securable occupiable space, of interacting with a personal mobile computing device of a person desiring to occupy the securable occupiable space, wherein the smart-structure has a first personal area network (PAN) communications system and the personal mobile computing device includes a second PAN communications system, the method comprising:
automatically establishing a PAN communications channel between the first PAN communications system and the second PAN communications system;
receiving credentials from the personal mobile computing device via the PAN communications channel;
verifying the credentials as being access credentials; and
triggering the access lock to unlock so as to permit the person to enter the securable occupiable space.

2. The method of claim 1, wherein establishing a wireless communications channel between the first and second PAN communications system includes using an Internet of Things (IoT) protocol.

3. The method of claim 1, wherein the first PAN communications system is a master radio and the second PAN communications system is a slave radio.

4. The method of claim 1, wherein the credentials include an authentication code that identifies the personal mobile computing device as being associated with an authorized user.

5. The method of claim 4, wherein the authentication code includes a media access control (MAC) address of the personal mobile computing device.

6. The method of claim 4, wherein the authorization code is authorized by an operator of the smart-structure.

7. The method of claim 1, wherein:
the smart-structure further includes:
an occupancy sensor that senses whether or not the securable interior space contains an occupant user; and
a controllable environment system for controlling at least one environmental aspect within the securable interior space; and
the method further comprises:
receiving an occupancy signal from the occupancy sensor based on the person being present in the securable interior space; and
in response to receiving the occupancy signal, allowing the person to control the controllable environmental system via the personal mobile computing device.

8. The method of claim 7, wherein the occupancy sensor includes an automatic presence sensor.

9. The method of claim 7, wherein the occupancy sensor includes an occupant-actuated sensor.

10. The method of claim 9, wherein the occupant-actuated sensor includes a deadbolt switch.

11. The method of claim 10, wherein the occupant-actuated sensor includes a doorjamb switch, and the method further includes, monitoring the doorjamb switch for at least one change in state signal and, in response to detecting the at least one change in state signal, allowing the person to control the controllable environmental system.

12. The method of claim 7, wherein the person is provided control of the controllable environmental system via a control interface accessible on the personal mobile computing device, and the method includes activating the control interface.

13. The method of claim 12, further comprising activating the control interface via the PAN communication channel.

14. The method of claim 12, wherein the personal mobile computing device has a smart-structure app, and the control interface is provided by the smart-structure app.

15. The method of claim 12, wherein the control interface is provided from a computing device located remotely from the personal mobile computing device, and activating the control interface includes activating the control interface via at least one of a wireless local area network and a cellular network.

16. The method of claim 15, wherein the personal mobile computing device includes an Internet browser, and the control interface is available to the person via the Internet browser.

17. The method of claim 12, wherein the control interface is provided from a computing device located remotely from the personal mobile computing device, and activating the control interface includes providing an access code to the personal mobile computing device.

18. The method of claim 17, further comprising providing the access code to the personal mobile computing device via the PAN communications channel.

19. The method of claim 1, wherein verifying the credentials includes checking the credentials against a verified-user credentials datastore.

20. The method of claim 19, wherein the verified-user credentials datastore is stored locally in a memory onboard the smart-structure.

21. The method of claim 1, wherein:
the smart-structure further includes an occupancy sensor that senses whether or not the securable occupiable space contains an occupant user, and the method further comprises:
receiving an occupancy signal from the occupancy sensor based on the person being present in the securable occupiable space; and
in response to receiving the occupancy signal, causing digital content to be presented to the person.

22. The method of claim 21, wherein the occupancy sensor includes an automatic presence sensor.

23. The method of claim 21, wherein the occupancy sensor includes an occupant-actuated sensor.

24. The method of claim 23, wherein the occupant-actuated sensor includes a deadbolt switch.

25. The method of claim 21, wherein the occupant-actuated sensor includes a doorjamb switch, and the method further includes, monitoring the doorjamb switch for at least one change in state signal and, in response to detecting the at least one change in state signal, causing the digital content to be presented to the person.

26. The method of claim 21, wherein causing digital content to be presented to the person includes presenting digital content to the personal mobile computing device.

27. The method of claim 1, wherein:
the smart-structure further includes an occupancy sensor that senses whether or not the securable occupiable space contains an occupant user, and the method further comprises:
receiving an occupancy signal from the occupancy sensor based on the person being present in the securable occupiable space; and
in response to receiving the occupancy signal, causing geotagged advertising to be presented to the person.

28. The method of claim 27, wherein the occupancy sensor includes an automatic presence sensor.

29. The method of claim 27, wherein the occupancy sensor includes an occupant-actuated sensor.

30. The method of claim 29, wherein the occupant-actuated sensor includes a deadbolt switch.

31. The method of claim 29, wherein the occupant-actuated sensor includes a doorjamb switch, and the method further includes, monitoring the doorjamb switch for at least one change in state signal and, in response to detecting the at least one change in state signal, causing the digital content to be presented to the person.

32. The method of claim 27, wherein causing geotagged advertising to be presented to the person includes providing the geotagged advertising to the personal mobile computing device.

33. The method of claim 1, further comprising causing the first PAN communications system to transmit an occupancy status signal indicating whether or not the securable occupiable space is occupied.

34. The method of claim 33, wherein the smart-structure includes a cellular radio, a wireless local area network (WLAN) radio, or both, the method further comprising causing at least one of the cellular radio and WLAN radio to transmit the occupancy status signal contemporaneously with the transmitting of the occupancy status signal by the first PAN communications system.

35. The method of claim 33, further comprising, in response to receiving the occupancy signal, changing the occupancy status signal from indicating vacancy to indicating occupancy.

36. The method of claim 1, further comprising, in response to receiving the occupancy signal, causing the first PAN radio to transmit a vacancy alert signal indicating that the smart-structure is available for use.

37. The method of claim 36, wherein the smart-structure includes a cellular radio, a wireless local area network (WLAN) radio, or both, the method further comprising causing at least one of the cellular radio and WLAN radio to transmit the vacancy alert signal contemporaneously with the transmitting of the vacancy alert signal by the first PAN communications system.

38. The method of claim 1, wherein the smart-structure further includes an occupancy sensor that senses whether or not the securable interior space contains an occupant user, the method further comprising:
receiving an occupancy signal from the occupancy sensor based on the person being present in the securable interior space; and
in response to receiving the occupancy signal, sending a message to the personal mobile computing device of the person, wherein the message is a message from a previous user of the securable occupiable space.

39. The method of claim 1, further comprising, based on verifying that the credentials are access credentials, sending a message to the personal mobile computing device of the person, wherein the message is a message from a previous user of the securable occupiable space.
